(19) United States
(12) Patent Application Publication
(10) Pub. No.: US 2015/0287492 A1
(43) Pub. Date: Oct. 8, 2015

(54) NON-HOMOGENEOUS COPPER-NICKEL COMPOSITE AND METHOD FOR SYNTHESIZING THE SAME

(71) Applicant: OCI COMPANY LTD., Seoul (KR)

(72) Inventors: Min-Kyung OH, Seongnam-si (KR); Sung-Koo KANG, Seongnam-si (KR); Ki-Hoon KIM, Seongnam-si (KR)

(21) Appl. No.: 14/676,307

(22) Filed: Apr. 1, 2015

(30) Foreign Application Priority Data
Apr. 2, 2014 (KR) 10-2014-0039419

(51) Int. Cl. H01B 1/02; C22C 9/06; C22B 15/00; C22C 1/00

(52) U.S. Cl. CPC H01B 1/026; C22C 1/00; C22C 9/06; C22B 15/0089

(57) ABSTRACT

A non-homogeneous copper-nickel composite and a method for synthesizing the same are disclosed. The non-homogeneous copper-nickel composite includes a higher amount of nickel in a surface portion of the composite than in a center portion thereof. The non-homogeneous copper-nickel composite exhibits sufficient oxidation resistance to prevent deterioration in electrical conductivity thereof due to an oxide layer formed on surfaces of particles during sintering while exhibiting a similar level of electrical conductivity to silver particles. In addition, the non-homogeneous copper-nickel composite can exhibit high adhesion to a coating metal layer.

### CROSS REFERENCE TO RELATED APPLICATION

This application claims the benefit of Korean Patent Application No. 10-2014-0039419, filed on Apr. 2, 2014, entitled “NON-HOMOGENEOUS COPPER-NICKEL COMPOSITE AND METHOD FOR SYNTHESIZING THE SAME”, which is hereby incorporated by reference in its entirety into this application.

### BACKGROUND

1. Technical Field

The present invention relates to a non-homogeneous copper-nickel composite and a method for synthesizing the same. More particularly, the present invention relates to a non-homogeneous copper-nickel composite, which includes a higher amount of nickel in a surface portion of the composite than in a center portion thereof, and a method for synthesizing the same.

2. Description of the Related Art

Metal powder materials are variously used for conductive pastes for electrode formation or die attachment, shielding pastes for shielding electromagnetic waves which can be generated from electronic packages, and the like.

Although high-priced metals such as silver (Ag), which exhibit excellent electrical conductivity, are mainly used for the pastes as set forth above, experiments for various metal materials have been continuously conducted to discover materials for replacing high-priced metals due to problems such as increase in price of raw materials, and migration.

In particular, although copper has proposed as a powerful substitute for high priced metals due to electrical conductivity which is not significantly lower than that of silver despite being 60 times cheaper than silver, copper has a problem of significant deterioration in conductivity since copper particles are oxidized during sintering due to insufficient oxidation resistance thereof.

Therefore, it is proposed that copper particles be used as a composite, such as a core-shell structure composite obtained by coating surface of the copper particles with silver (Korean Patent Registration Publication No. 10-0752533), a copper-nickel alloy composite (Korean Patent Laid-open Publication No. 1987-0011721), and the like.

However, the core-shell structure composite obtained by coating the surface of the copper particles with silver suffers from severe separation between two materials during sintering due to low adhesion between copper and silver. If separation between a core and a shell occurs during sintering, additional problems, such as deterioration in electrical conductivity due to oxidation of the exposed core particles, outflow of the core particles, and the like, can occur.

Moreover, the copper-nickel alloy composite has a problem in that it is difficult to adjust a ratio between copper and nickel at a specific point inside the composite even though there is a difference in reducing power between copper and nickel. Thus, there is no choice but to increase an amount of nickel in order to allow the composite to exhibit an appropriate level of oxidation resistance, thereby causing deterioration in electrical conductivity of the composite.

### BRIEF SUMMARY

Therefore, as a result of extensive efforts, the inventors of the present invention invented a non-homogeneous copper-nickel composite which resolves drawbacks of typical core-shell structures and alloys.

It is an aspect of the present invention to provide a non-homogeneous copper-nickel composite which exhibits sufficient oxidation resistance to prevent deterioration in electrical conductivity due to an oxide film formed on surfaces of particles during sintering while exhibiting a similar level of electrical conductivity to silver particles due to a higher amount of nickel in a surface portion of the composite than in a center portion thereof.

It is another aspect of the present invention to provide a core-shell composite which includes: a non-homogeneous copper-nickel composite including a higher amount of nickel in a surface portion of the composite than in a center portion thereof; and an electrically conductive metal layer coated onto the non-homogeneous copper-nickel composite, wherein the core-shell composite exhibits increased adhesion between the non-homogeneous copper-nickel composite and the electrically conductive metal layer. It is a further aspect of the present invention to provide a method for synthesizing a non-homogeneous copper-nickel composite including a higher amount of nickel in a surface portion of the composite than in a center portion thereof.

In accordance with one aspect of the present invention, there is provided a non-homogeneous copper-nickel composite including a higher amount of nickel in a surface portion of the composite than in a center portion thereof.

In accordance with another aspect of the present invention, there is provided a core-shell composite which includes: the non-homogeneous copper-nickel composite as set forth above; and an electrically conductive metal layer coated onto the non-homogeneous copper-nickel composite.

In accordance with a further aspect of the present invention, there is provided a method for synthesizing a non-homogeneous copper-nickel composite, which includes: preparing a metal salt solution by dissolving a copper salt and a nickel salt in a solvent; preparing a metal precursor solution by adding a first reductant and a dispersant to the metal salt solution; and reducing the metal precursor by adding a second reductant to the metal precursor solution, wherein the non-homogeneous copper-nickel composite includes a higher amount of nickel in a surface portion of the composite than in a center portion thereof depending upon a difference in reduction rate of the metal precursor.

According to one embodiment of the present invention, the non-homogeneous copper-nickel composite exhibits sufficient oxidation resistance to prevent deterioration in electrical conductivity due to an oxide film formed on the surface of the particles during sintering while exhibiting a similar level of electrical conductivity to silver particles. In addition, the non-homogeneous copper-nickel composite can exhibit high adhesion to the metal coating layer.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a diagram showing a distance from a center to a specific point of a non-homogeneous copper-nickel composite according to one embodiment of the present invention;

FIG. 2 shows SEM images of a non-homogeneous copper-nickel composite according to one embodiment of the present invention; and

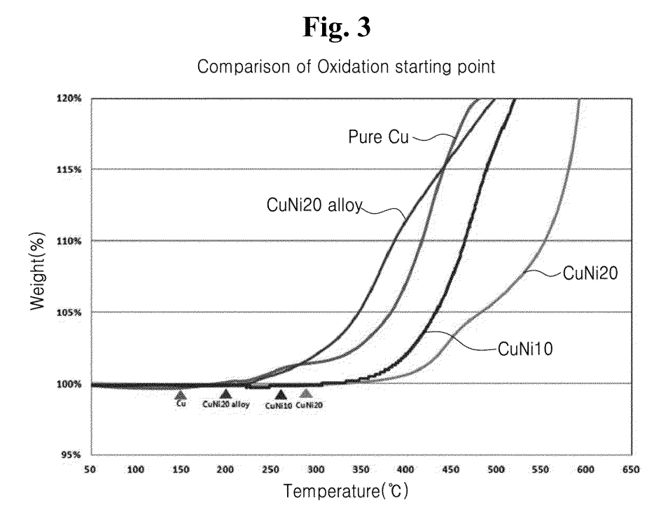

FIGS. 3 and 4 are graphs showing an oxidation temperature (temperature at which oxidation starts) of Examples and Comparative Examples.

### DETAILED DESCRIPTION

All terms and words used herein should not be construed as limited to common or lexical definitions and should be interpreted as having definitions and concepts corresponding to the spirit and scope of the present invention based on the principle that inventors may pertinently define concepts of the terms in order to describe their own disclosures in the best way. As used herein, the singular forms “a”, “an” and “the” are intended to include the plural forms as well, unless context clearly indicates otherwise.

In accordance with one aspect of the present invention, there is provided a non-homogeneous copper-nickel composite including a higher amount of nickel in a surface portion of the composite than in a center portion thereof.

According to one embodiment of the invention, a non-homogeneous copper-nickel composite is distinguished from a typical core-shell structure composite, in which a material forming a core and a material forming a shell are bonded to each other while forming an interface. In addition, the non-homogeneous copper-nickel composite according to the present invention is also distinguished from a typical alloy composite, in which metals forming an alloy are present in a specific ratio in a portion of the composite or throughout the composite.

According to one embodiment of the invention, the non-homogeneous copper-nickel composite has an exponential function or sigmoid function-shaped concentration-gradient structure, in which the amount of nickel is sharply increased with increasing distance from a center of the composite to a surface thereof, that is, in which the amount of nickel is higher in the surface portion of the composite than in the center portion thereof.

When a constant larger than 1 is a base and an arbitrary real number x is an exponent, the exponential function as used herein to represent the concentration-gradient structure refers to a function in which the base is raised to the power of x.

That is, according to this embodiment, the non-homogeneous copper-nickel composite follows the exponential function-shaped concentration-gradient structure in which the amount of nickel exponentially increases with increasing distance from the center of the composite to the surface thereof.

The sigmoid function as used herein to represent the concentration-gradient structure refers to a function which monotonically increases between two horizontal asymptotes.

That is, according to another embodiment, the non-homogeneous copper-nickel composite follows the concentration-gradient structure in which a probability of presence of nickel converges to 0% with decreasing distance to the center of the composite; a probability of presence of nickel converges to 100% with decreasing distance to the surface of the composite; and the amount of nickel sharply increases with increasing distance from the center to the surface.

As used herein, the term “uniformity or homogeneity” means that a state is physically or chemically the same throughout an object, for example, means that distribution of alloy elements is constant in the case of an alloy as a metal material. As used herein, the term “non-uniformity or non-homogeneity” means that a ratio between copper and nickel is not constant through the composite, that is, means that the amount of nickel sharply increases with increasing distance from the center of the composite to the surface thereof.

In particular, according to one embodiment of the present invention, when the distance from the center of the composite to the surface thereof, that is, a radius of the composite is R and a distance from the center of the composite to a specific point therein is r, “non-homogeneity” of the composite may be exhibited such that the amount of nickel included in a region of 0.8R≦r≦R is 80% by weight (wt %) to 99 wt % of the total amount of nickel included in the composite.

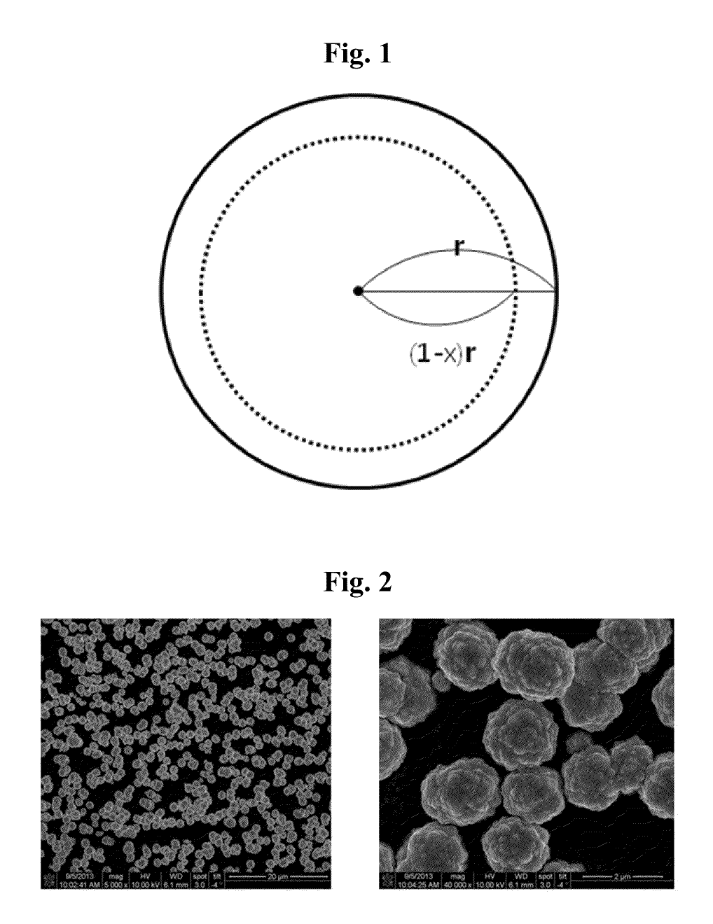

Referring to FIG. 1, R refers to the distance from the center of the composite to the surface thereof (that is, radius) under the assumption that the composite is a sphere (a dotted line shown in FIG. 1 does not represent an interface between copper and nickel layers). When the distance from the center of the composite to the specific point therein is r, the region of 0.8R≦r≦R corresponds to a region very close to the surface of the composite, and the amount of nickel included in the region is 80 wt % to 99 wt %, preferably 85 wt % to 99 wt %, more preferably 90 wt % to 99 wt % of the total amount of nickel. In addition, in another embodiment, the amount of nickel included in the region of 0.8R≦r≦R, preferably in a region of 0.9R≦r≦R, is 80 wt % to 99 wt % of the total amount of nickel.

Although the composite further includes nickel to supplement insufficient oxidation resistance, since nickel (electrical resistance of 69.3 nΩ·m at 20° C.) exhibits much lower electrical conductivity than silver (electrical resistance of 15.87 nΩ·m at 20° C.) and copper (electrical resistance of 16.78 nΩ·m at 20° C.), there is a problem in that the composite exhibits reduced electrical conductivity despite increased oxidation resistance when the amount of nickel exceeds a certain level based on the total weight of the composite. Therefore, according to one embodiment of the invention, the copper-nickel composite includes nickel in an amount of 0.1 wt % to 30 wt %, preferably 0.1 wt % to 20 wt %, based on the total weight of the composite.

According to one embodiment of the invention, the non-homogeneous copper-nickel composite exhibits improved oxidation resistance. Here, criteria for determining increase and decrease in oxidation resistance include “oxidation temperature”, which refers to a temperature at which oxidation starts, that is, a temperature at which an oxide layer starts to be formed on the surface of the composite.

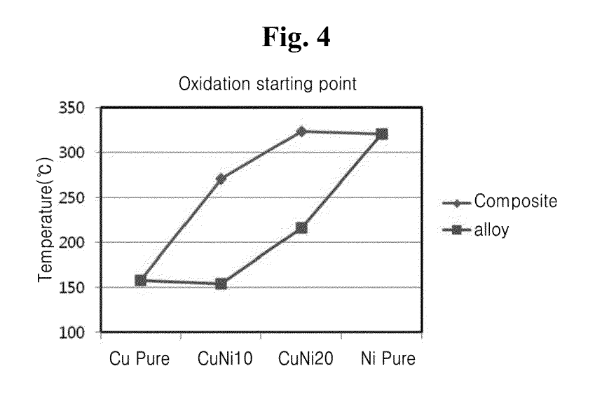

Pure copper particles have an oxidation temperature of about 150° C., and an alloy composite including 20 wt % of nickel based on the total weight of the composite has an oxidation temperature of about 200° C. (see FIG. 3). On the other hand, the composite according to one embodiment of the invention may have an oxidation temperature of 250° C. or more.

Such increase in oxidation resistance of the composite is not sufficiently achieved only by inclusion of nickel exhibiting higher oxidation resistance than copper in the composite (the oxidation temperature of the alloy composite is increased only by about 50° C. as compared with the copper particles alone), and it can be understood that increase in oxidation resistance of the composite is possible only if a specific amount of nickel is included in a certain region of the composite as in the embodiment of the invention.

According to the embodiment of the invention, the non-homogeneous copper-nickel composite may be mainly used as a metal powder material, which can be applied to conductive pastes used for wiring, electrode formation, die attachment and the like; shielding pastes for shielding electromagnetic waves which can be generated from electronic packages, and the like.

To this end, the composite according to one embodiment of the invention may have a diameter from 0.5 μm to 5 μm. If the diameter of the composite is greater than 5 μm, there is a problem in that an auxiliary component such as a surfactant for purposes of increase in dispersibility of the composite should be additionally used due to reduction in dispersibility thereof. In addition, if the diameter of the composite ranges from a few nanometers to tens of nanometers, there is a problem in that it is difficult to stack the metal powder for wiring or electrode formation.

According to one embodiment of the invention, the non-homogeneous copper-nickel composite is a mono-disperse system. As used herein, the term “mono-disperse” means that a dispersed phase has a uniform size.

In accordance with another aspect of the present invention, there is provided a core-shell composite which includes: the non-homogeneous copper-nickel composite as set forth above; and an electrically conductive metal layer coated onto the non-homogeneous copper-nickel composite. Here, the electrically conductive metal layer may include at least one metal selected from among platinum, nickel and silver, without being limited thereto. In addition, the electrically conductive metal layer may be selected from among electrically conductive metals exhibiting excellent adhesion to the non-homogeneous copper-nickel composite.

As described above, since copper is likely to be oxidized and loses electrical conductivity, despite having nearly the same electrical conductivity as that of silver, the core-shell structure composite in which copper is used as a core and a surface of the core is coated with silver has been proposed. However, since copper and silver have great repulsive force and low adhesion therebetween, separation between the two materials occurs during sintering.

According to one embodiment of the invention, the non-homogeneous copper-nickel composite maintains a high amount of nickel, which exhibits relatively good adhesion to silver, on the surface thereof, thereby reducing separation between the core and the shell during sintering.

Therefore, the core-shell composite according to the present invention can also simultaneously resolve other problems such as deterioration in electrical conductivity due to oxidation of the exposed core particles, outflow of the core particles, and the like.

In accordance with a further aspect of the present invention, there is provided a method for synthesizing a non-homogeneous copper-nickel composite including a higher amount of nickel in a surface portion of the composite than in a center portion thereof.

The synthesis method first begins with preparing a metal salt solution by dissolving a copper salt and a nickel salt in a solvent.

In one embodiment, the copper salt may include at least one selected from among Cu(NO₃)₂, CuCl₂, CuBr₂, CuI₂, Cu(OH)₂, CuSO₄, Cu(CH₃COO)₂ and Cu(CH₃COCHCOCH₃)₂, and the nickel salt may include at least one selected from among Ni(NO₃)₂, NiCl₂, NiBr₂, NiI₂, Ni(OH)₂, NiSO₄, Ni(CH₃COO)₂, and Ni(CH₃COCHCOCH₃)₂. Here, the nickel salt may be added in an amount of 0.01 equivalent weight to 1 equivalent weight based on 1 equivalent weight of the copper salt.

In one embodiment, the solvent may include at least one selected from among water, ethylene glycol, diethylene glycol, triethylene glycol, tetraethylene glycol, propylene glycol, dipropylene glycol, hexylene glycol, and 1,5-pentanediol.

Next, a first reductant and a dispersant are added to the prepared metal salt solution, thereby preparing a metal precursor solution.

In one embodiment, the first reductant may include at least one selected from among glucose, dimethylformamide (DMF), ascorbic acid, LiOH, NaOH, KOH, NH₄OH, (CH₃)₄NOH and aqueous solutions thereof, and the dispersant may include at least one selected from among polyvinylpyrrolidone (PVP), polyvinyl alcohol (PVA), cetyltrimethylammonium bromide (CTAB), cetyltrimethylammonium chloride (CTAC), polyacrylamide (PAA), sodium dodecyl sulfate (SDS), sodium carboxymethyl cellulose (Na-CMC), and gelatin.

As the first reductant and the dispersant are added to the metal salt solution in which the copper salt and the nickel salt are dissolved, a metal precursor precipitate may be formed. The precipitate is mixed with water, thereby preparing the metal precursor solution.

In one embodiment, preparation of the metal precursor solution by mixing the precipitate with water may be performed at 50° C. to 80° C. for prevention of excessive reduction of nickel.

Finally, the metal precursor may be reduced by adding a second reductant to the metal precursor solution, thereby synthesizing a non-homogeneous copper-nickel composite as a final product.

In one embodiment, the second reductant may include at least one selected from among hydrazine (N₂H₄), NaH₂PO₂, NaBH₄, LiAlH₄, formaldehyde, and (CH₃)₄NBH₄.

According to one embodiment, non-homogeneity of the composite may be determined based on a difference in reducing power of copper and nickel as well as a difference in reducing power of the solvent or the reductant, which is used in the synthesis method, or a manner of adding the reductant.

In one embodiment, the first reductant may be added at a rate of 0.1 ml/min to 2 ml/min, and the second reductant may be added dropwise at a rate of 0.1 ml/min to 10 ml/min. Here, the first reductant may also be added dropwise.

When the metal salt or the metal precursor solution is added to the solution in which the reductant is dissolved or a specified amount of the reductant is directly added to the metal precursor solution, there is a higher possibility of creation of the composite in which copper and nickel are uniformly distributed throughout the composite rather than having an exponential concentration-gradient structure.

Therefore, according to one embodiment of the invention, the first reductant added to synthesize the metal precursor and the second reductant added to synthesize the composite are added to the solution at a constant rate or at a regularly increasing rate. Here, these reductants may be dropwise added.

In one embodiment, the reducing power of the first reductant used for reduction of the metal salt and/or the metal precursor in the synthesis method may be lower than that of the second reductant.

The first reductant may have relatively low reducing power, that is, lower reducing power than the second reductant. The second reductant may have relatively high reducing power, that is, higher reducing power than the first reductant.

Types, amounts and the like of the first and second reductants may vary with reaction temperatures at which reduction is conducted, amounts used in reaction, types of the solvent, and the like.

In one embodiment, the first reductant may be added in an amount of 0.1 equivalent weight to 10 equivalent weight based on 1 equivalent weight of the added copper salt, and the second reductant may be added in an amount of 0.1 equivalent weight to 10 equivalent weight based on 1 equivalent weight of the added nickel salt, without being limited thereto. However, if the amount of the added reductant is less than 0.1 equivalent weight based on 1 equivalent weight of each of the copper salt and the nickel salt, each of the metal salts cannot be sufficiently reduced.

In some embodiments, the second reductant and the nickel salt may be simultaneously added dropwise.

When the metal salt solution is first prepared by dissolving the copper salt and the nickel salt in the solvent, independently of addition of the nickel salt, non-homogeneity of the composite may be secured by simultaneous addition of a certain amount of the nickel salt in conjunction with the second reductant in the operation of synthesizing the non-homogeneous composite by reducing the metal precursor solution. For example, a molar ratio of the nickel salt added for the preparation of the metal salt solution to the nickel salt added dropwise simultaneously with the second reductant may range from about 1:2 to about 1:4.

Hereinafter, the present invention will be described in more detail with reference to some examples. It should be understood that these examples are provided for illustration only and are not to be construed in any way as limiting the present invention.

### Preparation of Non-Homogeneous Copper-Nickel Composite

### Example 1

5 g of CuSO₄.5H₂O, 5.3 g of NiSO₄.6H₂O, 4 g of glucose and 4 g of gelatin were added to 80 ml of distilled water, and dissolved by heating to 70° C., thereby preparing a metal salt solution. Separately, 10 g of NaOH was dissolved in 40 g of distilled water, thereby preparing a NaOH solution. The NaOH solution was added dropwise to the metal salt solution at a rate of 1 ml/min. When a color of the solution changed to yellow, a precipitate was collected through centrifugation, and the collected precipitate was added to 80 g of distilled water in conjunction with 4 g of gelatin, followed by stirring at 70° C., thereby preparing a metal precursor solution.

40 ml of 25% hydrazine was added dropwise to the metal precursor solution at a rate of 0.1 ml/min to 10 ml/min (the rate of dropwise addition was regularly increased), followed by stirring at a temperature of 70° C. for 2 hours from a point of time at which dropwise addition of hydrazine started, thereby preparing a non-homogeneous copper-nickel composite.

### Example 2

16 g of CuSO₄.5H₂O, 4 g of NiSO₄.6H₂O, 8 g of glucose and 8 g of gelatin were added to 200 ml of distilled water, and dissolved by heating to 70° C., thereby preparing a metal salt solution. Separately, 20 g of NaOH was dissolved in 40 g of distilled water, thereby preparing a NaOH solution. The NaOH solution was added dropwise to the metal salt solution at a rate of 1 ml/min. When a color of the solution changed to yellow, a precipitate was collected through centrifugation, and the collected precipitate was added to 80 g of distilled water in conjunction with 4 g of gelatin, followed by stirring at 70° C., thereby preparing a metal precursor solution.

40 ml of 25% hydrazine was added dropwise to the metal precursor solution at a rate of 0.4 ml/min, followed by stirring at a temperature of 70° C. for 2 hours from a point of time at which dropwise addition of hydrazine started, thereby preparing a non-homogeneous copper-nickel composite.

### Example 3

12 g of CuSO₄.5H₂O, 8 g of NiSO₄.6H₂O, 8 g of glucose and 8 g of gelatin were added to 280 ml of distilled water, and dissolved by heating to 70° C., thereby preparing a metal salt solution. Separately, 10 g of NaOH was dissolved in 40 g of distilled water, thereby preparing a NaOH solution. The NaOH solution was added dropwise to the metal salt solution at a rate of 1 ml/min. When a color of the solution changed to yellow, a precipitate was collected through centrifugation, and the collected precipitate was added to 80 g of distilled water in conjunction with 4 g of gelatin, followed by stirring at 70° C., thereby preparing a metal precursor solution.

40 ml of 25% hydrazine was added dropwise to the metal precursor solution at a rate of 0.7 ml/min to 10 ml/min (the rate of dropwise addition was regularly increased), followed by stirring at a temperature of 70° C. for 2 hours from a point of time at which dropwise addition of hydrazine started, thereby preparing a non-homogeneous copper-nickel composite.

### Preparation of Core-Shell Composite Including Non-Homogeneous Copper-Nickel Composite

10.12 g of ascorbic acid and 4.25 g of tartaric acid were added to the solution including the prepared copper-nickel composite, and a solution in which 80.97 g of EDTA, 41.54 g of NaOH and 8.35 g of AgNO₃ were dissolved in 525 ml of water was injected into the solution including the prepared copper-nickel composite over 90 minutes using a solution injecting device, followed by reaction for 5 minutes even after completion of injection, thereby preparing a core-shell composite including the non-homogeneous copper-nickel composite.

High-Frequency Inductively Coupled Plasma (ICP) Mass Spectrometry of Non-Homogeneous Copper-Nickel Composite

ICP mass spectrometry is a method for quantitatively analyzing ionized atoms formed in an ICP light source by introducing the ionized atoms into a mass spectrometer. Mass of each of copper and nickel included in each of the non-homogeneous copper-nickel composites prepared in Examples was measured through ICP mass spectrometry.

Results of ICP mass spectrometry of the composites prepared in Examples 2 and 3 are shown in Table 1.

TABLE 1

| Specimen | Unit | Copper (Cu) | Nickel (Ni) |
|---|---|---|---|
| Example 2 | Mass % | 85.74 | 11.52 |
| Example 3 | Mass % | 75.86 | 23.73 |

From results of ICP mass spectrometry, it can be confirmed that the copper-nickel composite prepared in Examples satisfied the range of the amount of nickel of 0.1 wt % to 30 wt % based on the total weight of the composite.

Measurement of Oxidation Temperature (Oxidation Resistance) of Non-Homogeneous Copper-Nickel Composite

Thermogravimetric analysis (TGA) is a method for measuring a weight change of the composite along with temperature change. As the composites prepared in Examples and Comparative Example (Pure Cu and Pure Ni) were heated, a change in weight of each of the composites was traced. Results of TGA are shown in FIGS. 3 and 4 and Table 2.

TABLE 2

| | | Non-homogeneous |
|---|---|---|
| | Copper-nickel | copper-nickel |
| Specimen | alloy (° C.) | composite (° C.) |
| Pure Cu | 158 | 158 |
| CuNi₁₀ | 154 | 271 |
| CuNi₂₀ | 216 | 324 |
| Pure Ni | 321 | 321 |

As shown in the analysis results, the single composite composed of pure copper particles had an oxidation temperature of about 150° C., and the alloy composite including 20 wt % of nickel based on the total weight of the composite had an oxidation temperature of about 200° C. On the other hand, the composites of Example 2 (CuNi₁₀) and Example 3 (CuNi₂₀) had an oxidation temperature of about 250° C. or more.

In particular, since the composite of Example 3 had an almost similar oxidation temperature to pure Ni, it could be confirmed that the non-homogeneous copper-nickel composites of Examples secured sufficient oxidation resistance.

Increase in oxidation resistance of the composite along with increase in an amount of nickel is inversely proportional to electrical conductivity of the composite. Therefore, if the amount of nickel exhibiting higher oxidation resistance than copper is simply increased to improve oxidation resistance of the composite, it is difficult to apply the composite as a substitute for silver due to simultaneous reduction in electrical conductivity.

Therefore, according to the present invention, since the composite includes nickel, which can increase oxidation resistance and adhesion to silver, in a specific amount in a certain portion thereof, the problems as set forth above can be resolved.

As described above, the non-homogeneous copper-nickel composite according to embodiments of the present invention exhibits sufficient oxidation resistance to prevent deterioration in electrical conductivity due to an oxide layer formed on the surface of the particles during sintering, while exhibiting a similar level of electrical conductivity to silver particles. In addition, the non-homogeneous copper-nickel composite can exhibit high adhesion to the coating metal layer.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A non-homogeneous copper-nickel composite comprising: copper and nickel,
wherein nickel is present in a higher amount in a region of 0.8R≦r≦R than in a region of 0<r<0.8R, when a radius of the composite is R and a distance from a center of the composite to a specific point therein is r.

2. The copper-nickel composite according to claim 1, wherein the amount of nickel comprised in the region of 0.8R≦r≦R is 80 wt % to 99 wt % of the total amount of nickel comprised in the composite.

3. The copper-nickel composite according to claim 1, comprising: 0.1 wt % to 30 wt % of nickel based on the total weight of the composite.

4. The copper-nickel composite according to claim 1, wherein the composite has an oxidation temperature of 200° C. or more.

5. The copper-nickel composite according to claim 1, wherein the composite has a diameter from 0.5 μm to 5 μm.

6. The copper-nickel composite according to claim 1, wherein the composite is a mono-disperse copper-nickel composite.

7. A core-shell composite comprising:
the non-homogeneous copper-nickel composite according to claim 1; and
an electrically conductive metal layer coated onto the non-homogeneous copper-nickel composite.

8. The core-shell composite according to claim 7, wherein the electrically conductive metal layer comprises at least one metal selected from among platinum, nickel, and silver.

9. A method for synthesizing a non-homogeneous copper-nickel composite, comprising:
preparing a metal salt solution by dissolving a copper salt and a nickel salt in a solvent;
preparing a metal precursor solution by adding a first reductant and a dispersant to the metal salt solution; and
reducing the metal precursor by adding a second reductant to the metal precursor solution,
wherein the non-homogeneous copper-nickel composite comprises a higher amount of nickel in a surface portion of the composite than in a center portion thereof depending upon a difference in reduction rate of the metal precursor.

10. The method according to claim 9, wherein the copper salt comprises at least one selected from among Cu(NO₃)₂, CuCl₂, CuBr₂, CuI₂, Cu(OH)₂, CuSO₄, Cu(CH₃COO)₂, and Cu(CH₃COCHCOCH₃)₂.

11. The method according to claim 9, wherein the nickel salt comprises at least one selected from among Ni(NO₃)₂, NiCl₂, NiBr₂, NiI₂, Ni(OH)₂, NiSO₄, Ni(CH₃COO)₂, and Ni(CH₃COCHCOCH₃)₂.

12. The method according to claim 9, wherein the solvent comprises at least one selected from among water, ethylene glycol, diethylene glycol, triethylene glycol, tetraethylene glycol, propylene glycol, dipropylene glycol, hexylene glycol, and 1,5-pentanediol.

13. The method according to claim 9, wherein the first reductant comprises at least one selected from among glucose, dimethylformamide (DMF), ascorbic acid, LiOH, NaOH, KOH, NH₄OH, (CH₃)₄NOH, and aqueous solutions thereof.

14. The method according to claim 9, wherein the dispersant comprises at least one selected from among polyvinylpyrrolidone (PVP), polyvinyl alcohol (PVA), cetyltrimethylammonium bromide (CTAB), cetyltrimethylammonium chloride (CTAC), polyacrylamide (PAA), sodium dodecyl sulfate (SDS), sodium carboxymethyl cellulose (Na-CMC), and gelatin.

15. The method according to claim 9, wherein the first reductant is added at a rate of 0.1 ml/min to 2 ml/min.

16. The method according to claim 9, wherein the second reductant comprises at least one selected from among hydrazine (N₂H₄), NaH₂PO₂, NaBH₄, LiAlH₄, formaldehyde, and (CH₃)₄NBH₄.

17. The method according to claim 9, wherein the second reductant is added dropwise at a rate of 0.1 ml/min to 10 ml/min.

18. The method according to claim 9, wherein the first reductant has lower reducing power than the second reductant.

19. The method according to claim 17, wherein the second reductant and the nickel salt are simultaneously added dropwise.
